(19) United States
(12) Patent Application Publication
(10) Pub. No.: US 2014/0190245 A1
(43) Pub. Date: Jul. 10, 2014

(54) REDUCED PRESSURE LIQUID SAMPLING

(71) Applicant: 1ST DETECT CORPORATION, Austin, TX (US)

(72) Inventors: David Rafferty, Webster, TX (US); Abrar Riaz, Wilmington, DE (US); Michael Spencer, Manvel, TX (US); William R. Stott, King City (CA); James Wylde, Oak Leaf, TX (US)

(21) Appl. No.: 14/128,075

(22) PCT Filed: Jun. 21, 2012
(86) PCT No.: PCT/US2012/043557

§ 371 Date: Mar. 21, 2014

Related U.S. Application Data
(60) Provisional application No. 61/500,054, filed on Jun. 22, 2011.

(51) Int. Cl. G01N 1/28

(52) U.S. Cl. CPC G01N 1/28
USPC 73/64.56; 73/863; 73/864.81

(57) ABSTRACT

Processing a liquid sample (204) having an analyte (206) by reducing a pressure in a container (200) including the liquid sample to less than atmospheric pressure and maintaining a reduced pressure in the container. Reducing the pressure in the container (200) and optionally agitating the liquid sample increases an amount of vapor-phase analyte (206) above the liquid sample. In some cases, a concentration of the vapor-phase analyte is further increased, for example, with a chemical trap (502). The vapor-phase analyte can be provided to a chemical analyzer (302).

### CROSS-REFERENCE TO RELATED APPLICATIONS

This application claims priority to U.S. provisional application Ser. No. 61/500,054 filed on Jun. 22, 2011, which is hereby incorporated by reference herein.

### TECHNICAL FIELD

This invention is related to reduced pressure liquid sampling.

### BACKGROUND

Chemical analysis tools such as gas chromatographs (“GC”), mass spectrometers (“MS”), ion mobility spectrometers (“IMS”), and various others, are commonly used to identify trace amounts of chemicals, including, for example, chemical warfare agents, explosives, narcotics, toxic industrial chemicals, volatile organic compounds, semi-volatile organic compounds, hydrocarbons, airborne contaminants, herbicides, pesticides, and various other hazardous contaminant emissions in vapor phase samples. Detecting and analyzing trace amounts of chemicals in a liquid sample, however, may require additional preparation techniques, such as liquid chromatography, electrospray ionization, atmospheric pressure chemical ionization, or solid phase microextraction before introduction of the sample to a vapor phase detection device.

### SUMMARY

Implementations of the present disclosure are directed to devices, systems, and techniques for reduced pressure liquid sampling. In one general aspect, processing a liquid sample having an analyte includes reducing a pressure in a container including the liquid sample to less than atmospheric pressure, and maintaining a reduced pressure in the container. As described herein, reducing the pressure in the container increases an amount of vapor-phase analyte above the liquid sample. In another general aspect, a liquid sample processing system includes a container and a vacuum apparatus coupled to the container.

The liquid sampling processing system is configured to increase an amount of vapor-phase analyte above a liquid sample in the container by reducing a pressure in the container to less than atmospheric pressure and maintaining a reduced pressure in the container.

These and other implementations may each optionally include one or more of the following features. The liquid sampling processing system may include an agitating apparatus coupled to the container. The liquid sample may be agitated while maintaining a reduced pressure in the container. Agitating a liquid sample can include aerating the liquid sample using a pulsed valve, a leak valve, a vacuum regulator, or a combination thereof. Agitating the liquid sample may further include exciting the liquid with an ultrasonic transducer to increase the agitation efficiency. The container may be sealed such that the container is impermeable to air or nearly so. Reducing the pressure can include reducing the pressure to a pressure above that at which the liquid sample boils.

In some cases, some of the vapor-phase analyte may be removed from above the liquid sample, and a concentration of the vapor-phase analyte removed from above the liquid sample may be increased relative to a concentration of the vapor-phase analyte above the liquid sample. Increasing the concentration of the vapor-phase analyte removed from above the liquid sample relative to the concentration of the vapor-phase analyte above the liquid sample can include concentrating the vapor-phase analyte removed from above the liquid sample using a chemical trap, and releasing the vapor-phase analyte from the chemical trap to a chemical analyzer. In certain cases, a pressure in the chemical trap may be reduced before releasing the vapor-phase analyte to the chemical analyzer. The chemical analyzer may be, for example, a mass spectrometer, a gas chromatograph, an ion mobility spectrometer, or other chemical analyzers known in the art.

In some cases, the container may be sealed such that the container is air-tight, i.e., impermeable to air or nearly so. In certain cases, the container includes an inlet and an outlet for in-line liquid sampling. The liquid sample processing system may include a pressure monitoring apparatus coupled to the container, a pressure control apparatus coupled to the container, or both. The agitating apparatus may include, for example, a sparging apparatus, a mechanical apparatus, an ultrasonic apparatus, and the like, or any combination thereof In an example, a sparging apparatus includes a pulsed valve, a leak valve, a vacuum regulator, or a combination thereof A chemical trap, such as a pre-concentrator, may be coupled to the container. The chemical analyzer may be coupled to the container, the chemical trap, the vacuum apparatus, or any combination thereof.

As described herein, the liquid processing methods and apparatus include advantages of enhanced liberation of analyte from a liquid sample in the absence of heating the liquid sample, thus facilitating ease of sample processing. Systems and methods of reduced pressure liquid sampling can be used in applications including analysis of liquid samples for chemicals (e.g., toxic chemicals or chemical warfare agents), water distribution quality control, quality control of consumable liquids, and quality monitoring of reclaimed, reused, or recycled liquids.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 shows the Clausius-Clapeyron relationship for several chemicals.

FIG. 2 depicts an apparatus for reduced pressure liquid sampling.

FIG. 3 depicts a system for processing a liquid sample.

FIG. 4 depicts a system for processing a liquid sample.

FIG. 5 depicts a system for processing a liquid sample.

FIG. 6 depicts a system for processing a liquid sample.

FIG. 7 is a flowchart showing processing of a liquid sample.

FIG. 8 shows a mass spectrum of vapor from an aqueous sample with 10 ppb benzene and 10 ppb chloroform.

Like reference symbols in the various drawings indicate like elements.

### DETAILED DESCRIPTION

As described herein, reduced pressure liquid sampling is achieved by reducing a pressure in a container holding the liquid sample to less than atmospheric pressure, thereby increasing an amount of the analyte in the vapor phase above the liquid sample, and providing a portion of the vapor to a chemical analyzer. In the description below, for the purposes of explanation, specific examples related to assessing the presence of an analyte in an aqueous sample using a mass spectrometer have been set forth in order to provide a thorough understanding of the implementations of the subject matter described in this specification. It is appreciated that the implementations described herein can be utilized in other capacities as well and need not be limited to particular analytes, solvents, or chemical analyzers, but may be used to improve the operation of other devices and techniques. Accordingly, other implementations are within the scope of the claims.

To transition chemicals from a liquid or solid state, they are typically thermalized into a vapor phase, or boiled. The relationship between the rate at which molecules leave the surface of a liquid and enter the vapor phase and the temperature and pressure to which the chemical is subjected is well known. For example, the Clausius-Clapeyron relationship describes the pressure of a substance at a liquid-vapor boundary as a function of the temperature to which it is subjected according to:

$$ln \frac{{P}_{1}}{{P}_{2}} = \frac{Δ h}{R} ( \frac{1}{{T}_{2}} - \frac{1}{{T}_{1}} )$$

in which T₁ and P₁ are the temperature and pressure at a first state, respectively; T₂ and P₂ are the temperature and pressure at a second state, respectively; Δh is the change in specific enthalpy between the first state and the second state; and R is the universal gas constant.

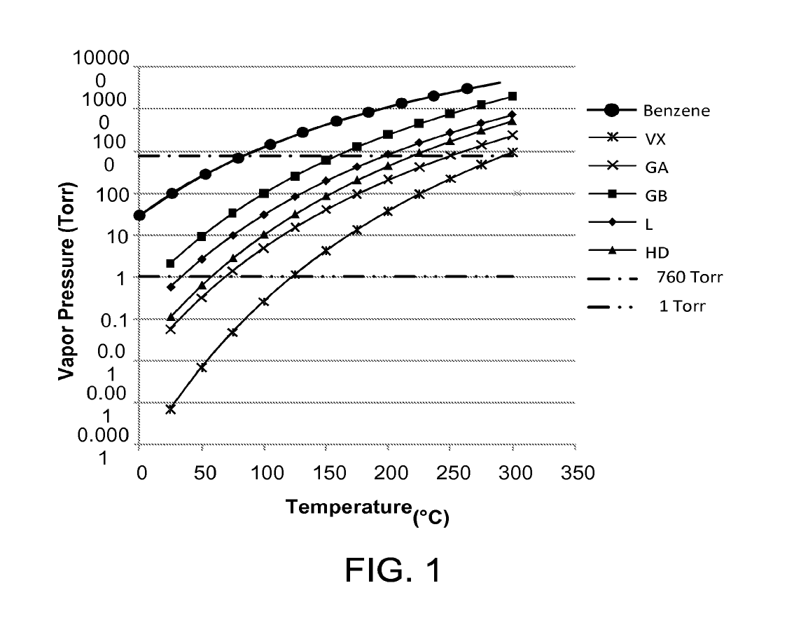

FIG. 1 shows the Clausius-Clapeyron relationship for chemical warfare agents VX (Methylphosphonothioic Acid), GA (Tabun), GB (Sarin), L (Lewisite), and HD (Sulfur Mustard or Yperite), as well as for benzene. 760 Torr and 1 Torr are indicated on the graph with horizontal lines. It is apparent that the temperature at which the liquids boil is reduced as the pressure to which the liquid is subjected is reduced. For example, the vapor pressure of Sarin at 100° C. is about 100 Torr. While heating an aqueous solution containing an analyte may enhance the liberation of the analyte from the solution, heating (e.g., to the boiling point of the solution) can also increase the difficulty of analyte collection and analysis. For example, instrumentation required to effect the heating may be more complex and require more power and time than desirable. In contrast, as described herein, liberation of an analyte from a liquid sample can be enhanced by reducing the pressure in a headspace above the liquid sample and agitating the sample while maintaining a reduced pressure in the headspace.

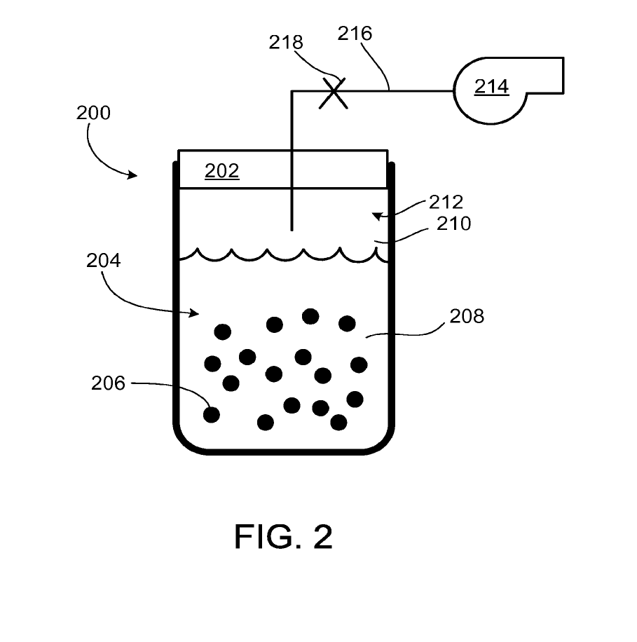

Referring to FIG. 2, container 200 is a sealable or air-tight container. In an example, container 200 is sealable with end cap 202. Liquid sample 204 in container 200 includes analyte 206 and solvent 208. The analyte may be a liquid at standard temperature and pressure. The solvent may include water, an organic solvent, or a mixture thereof Vapor 210 is present in container 200 in headspace 212 above liquid sample 204. Vacuum apparatus 214, coupled to container 200 via conduit 216, can be used to reduce the pressure inside container 200 to a pressure less than atmospheric pressure. Valve 218 may be positioned along conduit 216 to allow fluid communication between container 200 and vacuum apparatus 214.

Although liquid sample 204 is described for simplicity as including a single analyte and a single solvent, one of ordinary skill in the art would understand that a liquid sample can include more than one solvent, more than one analyte, or any combination thereof For the case of liquid sample 204 including one analyte and one solvent, the sum of partial pressures of the analyte and the solvent above the liquid sample, p_{T}, is given by Raoult's Law as:

p_{T}=p_{A}x_{A}+p_{S}x_{S}

where p_{A} and x_{A} are the vapor pressure of the pure analyte and the mole fraction of analyte 206 in the liquid sample, respectively, and p_{S} and x_{S} are the vapor pressure of the pure solvent and the mole fraction of solvent 208 in the liquid sample, respectively. The total pressure P_{T} inside the container is:

P_{T}=p_{B}+p_{T}=p_{B}+p_{A}x_{A}+p_{S}x_{S}

where p_{B} is the vapor pressure of the background matrix inside the closed container. The background matrix inside the closed container may include, for example, air or an inert gas. The partial pressure pᵢ of each component i is approximated by the ideal gas law as:

$${p}_{i} = \frac{{n}_{i} RT}{V}$$

in which the number of moles nᵢ of each component i varies directly with the partial pressure of that component for a given temperature T and volume V. The concentration (or mole fraction) C_{A} of analyte 206 in the vapor can be calculated as:

$${C}_{A} = \frac{{n}_{A}}{{n}_{T}} = \frac{{p}_{A} {x}_{A}}{{p}_{B} + {p}_{A} {x}_{A} + {p}_{S} {x}_{S}}$$

in which n_{T} is the total number of moles of analyte, solvent, and other components of the vapor phase. From Raoult's Law, further recognizing that P_{T}=p_{B}+p_{A}x_{A}+p_{S}x_{S}, the concentration of the analyte the vapor phase thus given as:

$${C}_{A} = \frac{{p}_{A} {x}_{A}}{{P}_{T}}$$

For a system at atmospheric pressure, the total pressure P_{T} is taken to be 760 Torr. For a liquid sample with an analyte concentration of 10 ppb (i.e., a mole fraction x_{A} of 10×10⁻⁹), the concentration of the analyte in the vapor phase above the liquid sample is calculated as:

$${C}_{A} = \frac{{p}_{A} {x}_{A}}{{P}_{T}} = \frac{{p}_{A} ( 10 \times 10 e - 9 )}{760}$$

In an example, analyte 206 is benzene, solvent 208 is water, and vapor 210 includes air. At standard conditions (T=25° C. and P_{T}=101.3 kPa or 760 Torr), the vapor pressure of benzene is 100 Torr and the vapor pressure of water is 23.8 Torr. The concentration of benzene in the vapor is

$${C}_{benzene} = \frac{100 ( 10 \times 10 e - 9 )}{760} = 1.3 \times 10 e - 9$$

Thus, when the liquid sample is at atmospheric pressure, the concentration of benzene in the vapor phase is 1.3 ppb. If, however, the pressure in container 200 is reduced to 25 Torr, then:

$${C}_{benzene} = \frac{{p}_{benzene} {x}_{benzene}}{{P}_{T}} = \frac{100 ( 10 \times 10 e - 9 )}{25} = 4 \times 10 e - 8$$

Thus, when the internal pressure of the container is 25 Torr, the concentration of benzene in the vapor is 40 ppb.

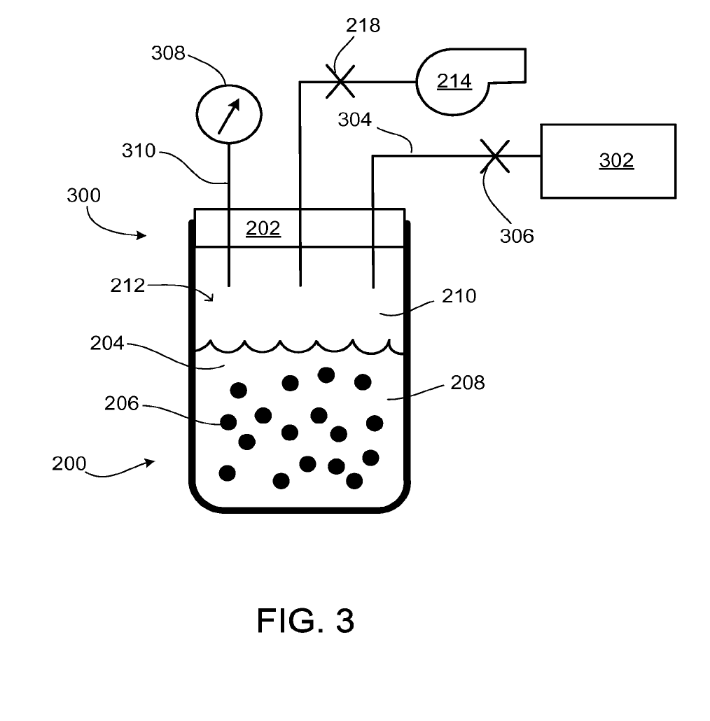

Referring to system 300 in FIG. 3, liquid sample 204 including analyte 206 and solvent 208 is shown in container 200. In some cases, liquid sample 204 is collected in container 200, and the container is sealed with end cap 202 to form a closed container. Chemical analyzer 302 is in fluid communication with container 200 via conduit 304 and valve 306. Pressure measurement apparatus 308 is in fluid communication with container 200 via conduit 310. Chemical analyzer 302 and pressure measurement apparatus 308 may be in switchable fluid communication with container 200. Chemical analyzer 302 may be, for example, a mass spectrometer, a gas chromatograph, or an ion mobility spectrometer.

To process the liquid sample 204, vacuum apparatus 214 may be activated to remove at least a portion of vapor 210 from container 200. The pressure in container 200 may be monitored by pressure measurement apparatus 308. When a suitable pressure has been reached in container 200, vacuum apparatus 214 can be fluidically disconnected from the container, which may include terminating operation of the vacuum apparatus or closing valve 218. A suitable pressure may be, for example, less than atmospheric pressure but above the boiling point of liquid sample 204 (e.g., above the boiling point of solvent 208). After equilibrium is achieved, fluid communication between container 200 and chemical analyzer 302 is activated, and presence of analyte 206 in vapor 210 (and thus liquid sample 204) is assessed by the chemical analyzer. It should be noted that those skilled in the art may recognize other methods of effecting fluid communication between the elements of this embodiment without deviating from the teachings of this disclosure. For example, vacuum apparatus 214 may be configured to communicate with container 200 through chemical analyzer 302.

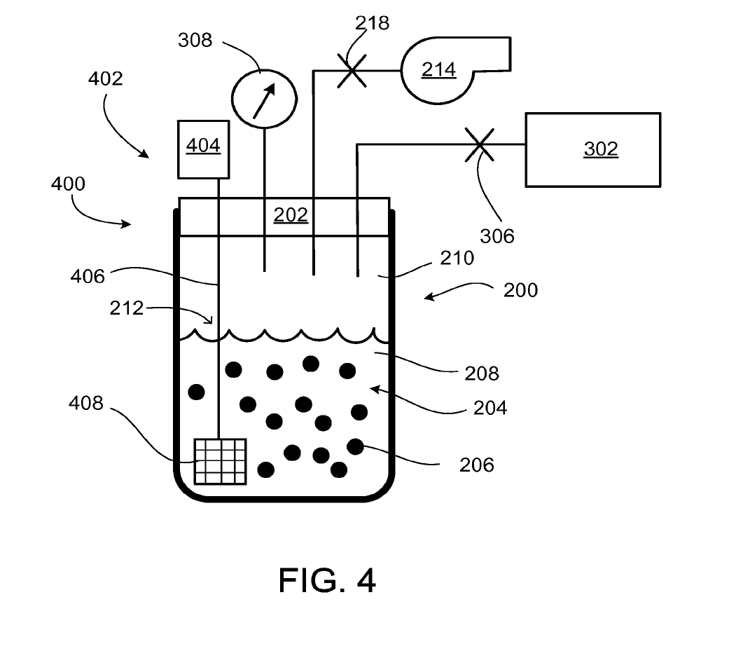

In some cases, a liquid sample is agitated by sparging, mechanical agitation, ultrasonic agitation, fluid agitation, or any combination thereof. In an example, system 400 in FIG. 4 includes agitating apparatus 402, including pressure control apparatus 404, conduit 406, and sparging apparatus 408. Conduit 406 extends into liquid sample 204. Pressure control apparatus 404 may include, for example, a vacuum regulator, a pulsed micro-valve, or a pinch valve. Those skilled in the art would recognize that other forms of pressure control exist. Sparging apparatus 408 may include, for example, a sparger or a bubbling stone for enhancing fluid flow.

To process the in liquid sample 204, vacuum apparatus 214 may be activated to remove at least a portion of vapor 210 from container 200 (e.g., from headspace 212). The pressure in container 200 may be monitored by pressure measurement apparatus 308. When a suitable pressure has been reached in container 200, vacuum apparatus 214 can be fluidically disconnected from the container, which may include terminating operation of the vacuum apparatus or closing valve 218. Pressure control apparatus 404 may be operated to allow atmospheric vapor (e.g., air) to enter liquid sample 204 via conduit 402, such that a stream of bubbles from sparging apparatus 408 agitates analyte 206 in the liquid sample, facilitating diffusion of the analyte from the liquid sample into vapor 210 while substantially maintaining the reduced pressure obtained by vacuum apparatus 214. Using, for example, a pulsed valve as pressure control apparatus 404 allows more vigorous bubbling at a given average pressure than could be obtained by a constant pressure type device such as a vacuum regulator. After a suitable time has elapsed, fluid communication between container 200 and chemical analyzer 302 is initiated and the presence of analyte 206 in vapor 210 (and thus in liquid sample 204) is assessed. It should be noted that those skilled in the art may recognize other methods of effecting fluid communication between the elements of this embodiment without deviating from the teachings of this disclosure. For example, vacuum apparatus 214 may be configured to communicate with container 200 through chemical analyzer 302.

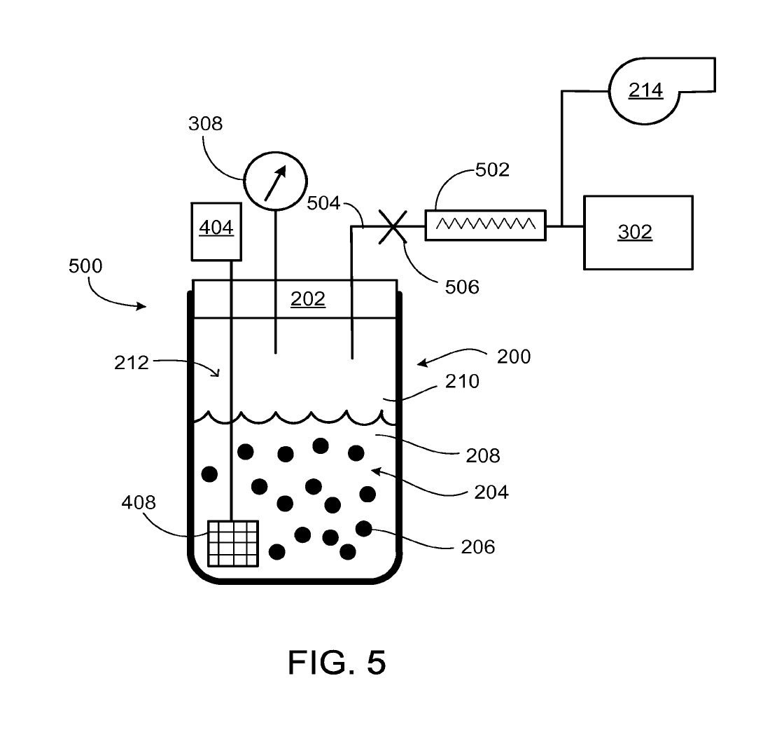

Referring to system 500 in FIG. 5, trapping apparatus 502 is in fluid communication with container 200 via conduit 504 and valve 506. Trapping apparatus 502 is also in fluid communication with vacuum apparatus 214 and chemical analyzer 302. Trapping apparatus 502 can be used to further increase a concentration of analyte 206 in vapor provided to chemical analyzer 302. In some cases, trapping apparatus 502 is a chemical trap. The chemical trap may include, for example, a pre-concentrator as described in more detail in Appendix A. Some chemical traps trap more efficiently at reduced are velocity which is enabled by the reduced pressure flow. The reduced pressure also reduces the likelihood for the analyte to condense on the inner walls of conduit 504.

To process the liquid sample 204, vacuum apparatus 214 may be activated to remove at least a portion of vapor 210 from container 200. The pressure in container 200 may be monitored by pressure measurement apparatus 308. When a suitable pressure has been reached in container 200, pressure control apparatus 404 may be operated to allow atmospheric vapor (e.g., air) to enter liquid sample 204 via conduit 406, such that a stream of bubbles agitates analyte 206 in the liquid sample, facilitating diffusion of the analyte from the liquid sample into vapor 210, while maintaining the contents of container 200 at a suitable (e.g., reduced) pressure. In addition, the liquid sample 204 may optionally be agitated ultrasonically, concurrently with the bubbling process, in order to increase the surface area of the bubbles and to increase the agitation efficiency.

Valve 506 and vacuum apparatus 214 may be operated to allow analyte 204 in vapor 210 to flow through trapping apparatus 502, and at least a portion of the analyte may be sorbed by sorbent material in the trapping apparatus. When a suitable amount of analyte has been sorbed by trapping apparatus 502, fluid communication between the trapping apparatus and container 200 is closed via valve 506 or other suitable means. At least a portion of the background matrix in trapping apparatus 502 is removed via a pumping mechanism which may include vacuum apparatus 214 or a pumping apparatus otherwise coupled to chemical analyzer 302. When a suitable amount of background matrix has been removed from trapping apparatus 502, vapor including the sorbed analyte is released into chemical analyzer 302. The presence of analyte 206 in the vapor can be assessed (e.g., qualitatively or quantitatively). The presence of analyte 206 in the liquid sample can be assessed based on the presence of the analyte in the vapor. It should be noted that those skilled in the art may recognize other methods of effecting fluid communication between the elements of this embodiment without deviating from the teachings of this disclosure. For example, vacuum apparatus 214 may be configured to communicate with container 200 through chemical analyzer 302, or the vacuum apparatus and the chemical analyzer may be separated from trapping apparatus 502 by independent valves. Also, trapping apparatus 502 may assume a different configuration than described.

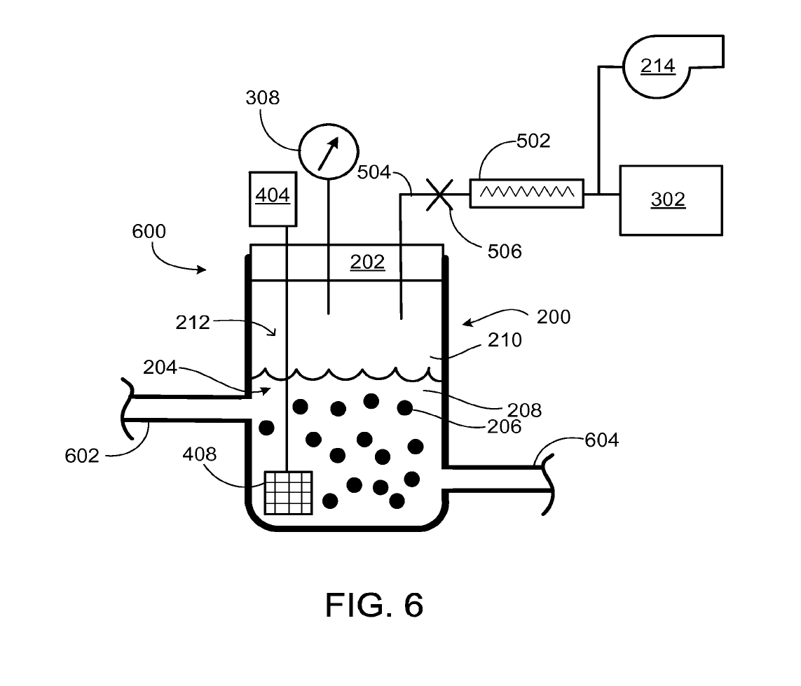

FIG. 6 depicts in-line liquid sampling system 600. System 600 includes inlet 602 and outlet 604. System 600 can include features similar to those described with respect to system 500 in FIG. 5. However, as shown in FIG. 6, liquid sample 204 can enter container 200 through inlet 602 and exit the container through outlet 604 for in-line processing of the liquid sample. Inlet 602 and outlet 604 can be, for example, conduits in a water treatment system, a food/beverage manufacturing system, or a liquids processing facility, in which the liquid sample processing can be utilized for water distribution quality control, quality control of consumable liquids, and quality monitoring of reclaimed, reused, or recycled liquids. In this configuration, a vacuum could be maintained in the vapor above the liquid surface in the container while still allowing uninterrupted flow of liquid in and out of the container by using a tall container extending above inlet 602 and outlet 604. The weight of the liquid would create a vacuum at the top of the container based on the weight of the liquid above inlet 602 and outlet 604, as long as no substantial amount of gas phase material was allowed to enter inlet 602 or outlet 604. Alternatively, inlet 602 and outlet 604 may be valved to allow periodic isolation of the container in order to perform the reduced pressure sampling.

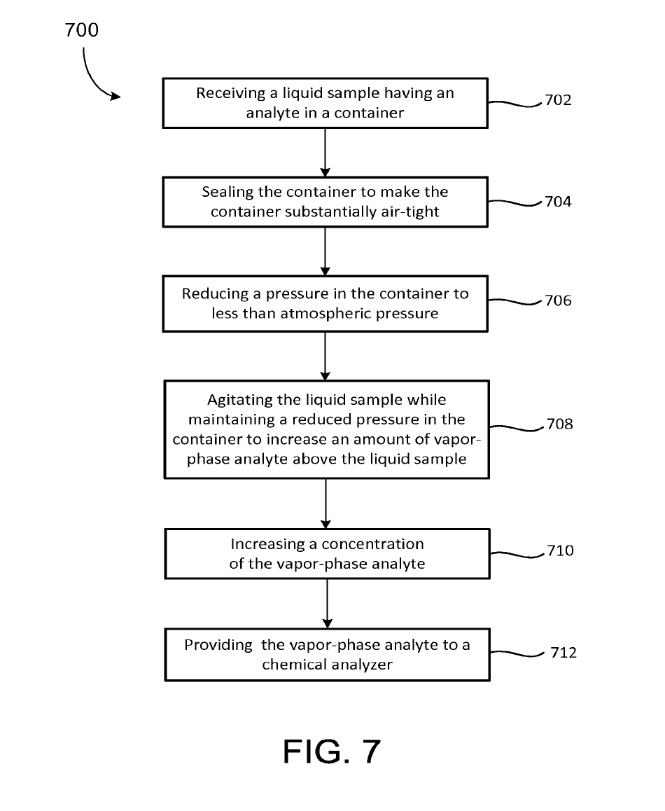

FIG. 7 shows a flow chart of process 700 for processing a liquid sample. In 702, a liquid sample having an analyte is introduced in a container. The container is made air-tight 704, and a pressure in the container is reduced to less than atmospheric pressure 706. The liquid sample is agitated (e.g., sparged) 708 while maintaining a reduced pressure in the container to increase a quantity of vapor-phase analyte above the liquid sample. In some cases, a concentration of the vapor-phase analyte is increased 710. Increasing a concentration of the vapor-phase analyte may include, for example, providing vapor from the container to a pre-concentrator, such as described in Patent Cooperation Treaty (PCT) Application No. PCT/US2010/047015, entitled “PRECONCENTRATING A SAMPLE,” filed Aug. 27, 2010, the full disclosure of which is hereby incorporated by reference. In 712, the vapor-phase analyte is provided to a chemical analyzer. The presence of the analyte can be assessed (e.g., qualitatively or quantitatively). The presence of the analyte in the liquid sample may be assessed based on the presence of the vapor-phase analyte. In some embodiments, elements may be added to or removed from process 700. In certain embodiments, process 700 may be achieved in an order other than that shown in FIG. 7.

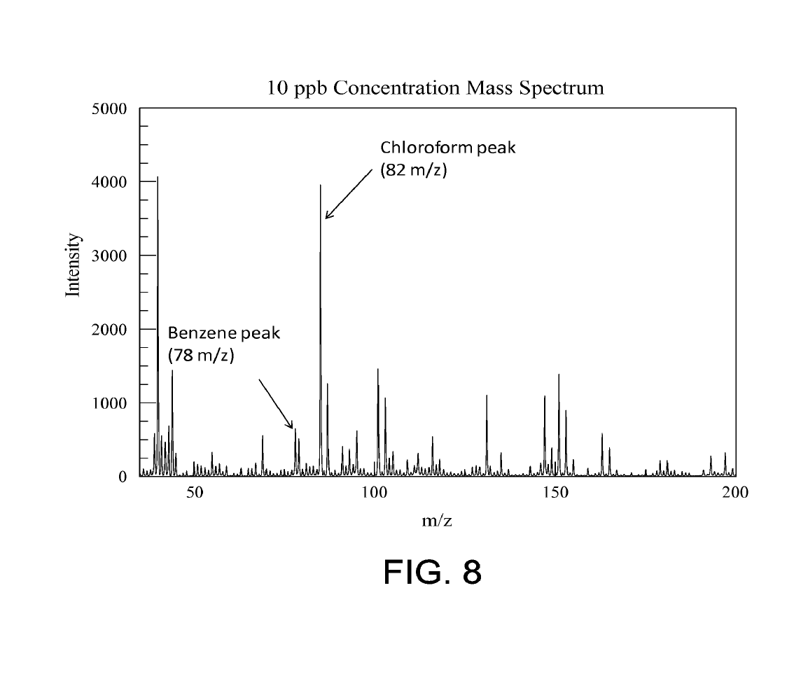

FIG. 8 shows a mass spectrum from an aqueous sample having 10 ppb benzene and 10 ppb chloroform.

A number of embodiments of the invention have been described. Nevertheless, it will be understood that various modifications may be made without departing from the spirit and scope of the invention. For example, some implementations may include one or more agitators to aid in the release of the analyte from the liquid sample. Further, multiple pumps and/or valves may be included in one or more vacuum paths to evacuate the container and/or to eliminate redundant system components or to facilitate the re-pressurization of the container. Accordingly, other embodiments are within the scope of the following claims.

1. A method of processing a liquid sample comprising an analyte, the method comprising:
reducing a pressure in a container comprising the liquid sample to less than atmospheric pressure;
wherein reducing the pressure in the container increases an amount of vapor-phase analyte above the liquid sample.

2. The method of claim 1, further comprising agitating the liquid sample while maintaining a reduced pressure in the container.

3. The method of claim 2, wherein agitating the liquid sample comprises aerating the liquid sample using one or more of a pulsed valve, a leak valve, and a vacuum regulator.

4. The method of claim 3, wherein agitating the liquid sample further comprises exciting the liquid sample with an ultrasonic transducer to increase the agitation efficiency.

5. The method of claim 4, further comprising sealing the container such that the container is air-tight.

6. The method of claim 5, wherein reducing the pressure comprises reducing the pressure to a pressure above that at which the liquid sample boils.

7. The method of any claim 6, further comprising removing some of the vapor-phase analyte from above the liquid sample, and increasing a concentration of the vapor-phase analyte removed from above the liquid sample relative to a concentration of the vapor-phase analyte above the liquid sample.

8. The method of claim 7, wherein increasing the concentration of the vapor-phase analyte removed from above the liquid sample relative to the concentration of the vapor-phase analyte above the liquid sample comprises concentrating the vapor-phase analyte removed from above the liquid sample using a chemical trap, and releasing the vapor-phase analyte from the chemical trap to a chemical analyzer.

9. The method of claim 8, further comprising reducing a pressure in the chemical trap before releasing the vapor-phase analyte to the chemical analyzer.

10. The method of claim 9, wherein the chemical analyzer comprises a mass spectrometer.

11. A liquid sample processing system comprising:
a container; and
a vacuum apparatus coupled to the container;
wherein the liquid sampling processing system is configured to increase an amount of vapor-phase analyte above a liquid sample in the container by reducing a pressure in the container to less than atmospheric pressure.

12. The liquid sample processing system of claim 11, further comprising an agitating apparatus coupled to the container.

13. The liquid sampling processing system of claim 12, wherein the container comprises an inlet port and an outlet port.

14. The liquid sample processing system of claim 13, further comprising a pressure monitoring apparatus coupled to the container.

15. The liquid sample processing system of claim 14, further comprising a pressure control apparatus coupled to the container.

16. The liquid sample processing system of claim 15, wherein the agitating apparatus comprises a sparging apparatus.

17. The liquid sample processing system of claim 16, wherein the sparging apparatus comprises one or more of a pulsed valve, a leak valve, and a vacuum regulator.

18. The liquid sample processing system of claim 17, wherein the agitating apparatus further comprises an ultrasonic agitator to increase the agitation efficiency.

19. The liquid sample processing system of claim 18, further comprising a chemical trap coupled to the container.

20. The liquid sample processing system of claim 19, wherein the chemical trap is a pre-concentrator.

21. The liquid sample processing system of claim 20, further comprising a chemical analyzer coupled to one or more of the container, the chemical trap, and the vacuum apparatus.

22. The liquid sample processing system of claim 21, wherein the chemical analyzer comprises a mass spectrometer.
